(19) United States
(12) Patent Application Publication
(10) Pub. No.: US 2004/0256218 A1
(43) Pub. Date: Dec. 23, 2004

(54) Thin films and methods of forming thin films utilizing ECAE-targets

(76) Inventors: Howard L. Glass, Spokane, WA (US); Stephane Ferrasse, Veradale, WA (US); Frank Alford, Veradale, WA (US)

Correspondence Address: WELLS ST. JOHN P.S., 601 W. FIRST AVENUE, SUITE 1300, SPOKANE, WA, 99201, US

(21) Appl. No.: 10/436,724

(22) Filed: May 12, 2003

Related U.S. Application Data
(60) Provisional application No. 60/384,890, filed on May 31, 2002.

(51) Int. Cl. B32B 9/00

(52) U.S. Cl. 204/192.2; 420/528; 428/692

(57) ABSTRACT

The invention includes methods of forming a barrier layer. Material is ablated from an ECAE target to form a layer having a thickness variance of less than or equal to 1% of 1-sigma across a substrate surface. The invention includes a method of forming a tunnel junction. A thin film is formed between first and second magnetic layers. The thin film, the first magnetic layer, and/or the second magnetic layer are formed by ablating material from an ECAE target to provide improved layer thickness uniformity relative to corresponding layers formed utilizing non-ECAE targets. The invention includes a physical vapor deposition target and a thin film formed using the target. The target contains an alloy of aluminum and at least one alloying element selected from Ga, Zr and In. The resulting film has a thickness variance across the thin film of less than 1.5% of 1-sigma.

### RELATED PATENT DATA

This patent claims benefit of priority under 35 U.S.C. §119 to U.S. Provisional Patent Ser. No. 60/384,890, which was filed May 31, 2002.

### TECHNICAL FIELD

The invention pertains to physical vapor deposition targets, thin films, thin film stacks and methods of forming thin films and thin film comprising structures.

### BACKGROUND OF THE INVENTION

In particular technologies and applications, layers of materials are desired to be extremely thin, for example less than 100 nm, and in particular instances are desired to be less than 10 nm or even less than 1 nm. Further, some applications utilize thin film stacks having a plurality of very thin layers. Uniformity of material thickness, structure, and smoothness can be extremely important factors in the quality of thin films. Accordingly, methods of deposition that can accurately and reproducibly provide smooth, uniform film products are highly desirable.

PVD is a technology by which thin metallic and/or ceramic layers can be sputter-deposited onto a substrate. Sputtered materials are ablated from a target, which serves generally as a cathode in a standard radio frequency (RF) and/or direct current (DC) sputtering apparatus. For example, PVD is widely used in the semiconductor industry to produce integrated circuits. However, thin films formed by PVD utilizing conventional sputtering targets can lack the thickness uniformity, absence of particle defects and pinholes, resistance uniformity, or appropriate microstructure for applications where such factors can be critical.

A relatively new application for sputtering technologies is in the fabrication of magnetic random access memory devices (MRAMs), particularly in forming thin films in structures such as spin-valves and magnetic tunnel junctions (MTJ). Because MRAM is non-volatile memory (stored information is not lost upon turning off the memory), development of MRAM technology is becoming increasingly important for high-speed processing of information.

Generally, an MRAM cell can have a sub-micron critical dimension. MRAM cells typically include a thin film stack having at least two magnetic layers separated by a non-magnetic layer. The non-magnetic layer can be a conductive layer in the case of spin-valves, or can be an insulative barrier layer in the case of MTJs. Uniformity of film composition, microstructure and thickness can be essential for proper MRAM device function. For example, in MTJ applications the current flows perpendicular to the film plane and the tunneling resistance is therefore exponentially dependent upon the thickness of the barrier layer. Accordingly, a small variance in layer thickness can result in a large variance in resistance. Additionally, the thickness of magnetic layers in MRAM devices are related to the current (or field) required to switch magnetic vectors. Because the absolute value of the MTJ resistance is compared to a reference cell during read mode, layer qualities such as an absence of particle defects or pinholes, composition uniformity and purity (i.e. absence of contaminants), layer smoothness, and extreme uniformity in layer thickness are essential for absolute resistance of the cell.

Several factors are important in sputter deposition of a uniform layers having desired properties for MRAM devices. Such factors include: sputtering rate; thin film uniformity; and microstructure. Improvements are desired in the metallurgy of targets to improve the above discussed factors. Aluminum can be a particularly useful metal in forming layers and thin films such as tunneling barrier layers in MTJ applications. Copper and/or copper alloys can be similarly useful in spin-valve devices. Ferromagnetic materials such as cobalt alloys and nickels alloys, and anti-ferromagnetic materials such as Mn-based materials, are also useful for forming magnetic and pinning layers respectively. High-purity metals and alloys are preferred to minimize or avoid non-uniform composition or contaminants that can affect local resistance or spin orientation. Accordingly, it can be desired to form high-purity aluminum-comprising physical vapor deposition targets and targets comprising high-purity ferromagnetic material or anti-ferromagnetic material that can be utilized for MRAM applications.

Various works demonstrate that three fundamental factors of a target can influence sputtering performance. The first factor is the grain size of the material, i.e. the smallest constitutive part of a polycrystalline metal possessing a continuous crystal lattice. Grain size ranges are usually from several millimeters to a few tenths of microns; depending on metal nature, composition, and processing history. It is believed that finer and more homogeneous grain sizes improve thin film uniformity, sputtering yield and deposition rate, while reducing arcing. The second factor is target texture. The continuous crystal lattice of each grain is oriented in a specific way relative to the plane of target surface. The sum of all the particular grain orientations defines the overall target orientation. When no particular target orientation dominates, the texture is considered to be a random structure. Like grain size, crystallographic texture can strongly depend on the preliminary thermomechanical treatment, as well as on the nature and composition of a given metal. Crystallographic textures can influence thin film uniformity and sputtering rate.

The third factor is the size and distribution of structural components, such as second phase precipitates and particles, and casting defects (such as, for example, voids or pores). These structural components are usually not desired and can be sources for arcing as well as contamination of thin films.

In order to improve the manufacture of MRAM targets it would be desirable to accomplish one or more of the following relative to target materials: (1) to achieve predominate and uniform grain sizes within the target materials of less than 100 μm; (2) to have the target materials consist of (or consist essentially of) high-purity metal or high-purity metal alloys (i.e. aluminum of at least 99.99% (4N) purity, and preferably at least 99.999% (5N) purity, with the percentages being atomic percentages); and (3) to keep oxygen content within the target materials low.

The thermomechanical processes (TMP) used traditionally to fabricate physical vapor deposition targets can generally only achieve grain sizes larger than 200 μm for 5N Al, with or without dopants, or aluminum based alloys. Such TMP processes involve the different steps of casting, heat treatment, forming by rolling or forging, annealing and final fabrication of the target. Because forging and rolling operations change the shape of billets by reducing their thickness, practically attainable strains in today's TMP processes are restricted. Further, rolling and forging operations generally produce non uniform straining throughout a billet.

The optimal method for refining the structure of high-purity aluminum alloys (such as, for example, 99.9995% aluminum) or other metal alloys would be intensive plastic deformation sufficient to initiate and complete self-recrystallization at room temperature immediately after cold working.

High-purity metals and alloys are typically provided as a cast ingot with coarse dendrite structures (FIG. 1 illustrates a typical structure of as cast 99.9995% aluminum). Forging and/or rolling operations are utilized to deform the cast ingots into target blanks. The total strains which can be obtained for any combination of forging and/or rolling operations can be expressed as ε=(1-h/Ho)*100%; where Ho is an ingot length, and h is a target blank thickness. Calculations show that possible thickness reductions for conventional processes range from about 85% to about 92%, depending on target blank size to thickness ratio. The thickness reduction defines the strain induced in a material. Higher thickness reductions indicate more strain, and accordingly can indicate smaller grain sizes. The conventional reductions of 85% to 92% can provide static recrystallization of high-purity aluminum (for instance, aluminum having a purity of 99.9995% or greater) but they. are not sufficient to develop the fine and uniform grain structure desired for MRAM target materials. For example, an average grain size after 95% rolling reduction is about 150 microns (such is shown in FIG. 2). Such grain size is larger than that which would optimally be desired for tunnel barrier formation. Further, the structures achieved by conventional processes are not stable. Specifically, if the structures are heated to a temperature of 150° C. or greater (which is a typical temperature for sputtering operations), the average grain size of the structures can grow to 280 microns or more (see FIG. 3). Such behavior occurs even after intensive forging or rolling.

FIG. 4 summarizes results obtained for a prior art high-purity aluminum material. Specifically, FIG. 4 shows a curve 10 comprising a relationship between a percentage of rolling reduction and grain size (in microns). A solid part of curve 10 shows an effect of rolling reduction on a 99.9995% aluminum material which is self-recrystallized at room temperature. As can be seen, even a high rolling reduction of 95% results in an average grain size of about 160 microns (point 12), which is a relatively coarse and non-uniform structure. Annealing at 150° C. for 1 hour significantly increases the grain size to 270 microns (point 14). An increase of reduction to 99% can reduce the grain size to 110 microns (point 16 of FIG. 4), but heating to 150° C. for 1 hour increases the average grain size to 170 microns (point 18 of FIG. 4).

Attempts have been made to stabilize structures of recrystallized high-purity materials by adding low amounts of different doping elements (such as silicon, titanium and scandium in the case of high-purity aluminum) to the materials. A difficulty that occurs when the doping elements are incorporated is that full self-recrystallization can generally not be obtained for an entirety of the material, and instead partial recrystallization is observed along grain boundaries and triple joints. For example, the structure of a material comprising 99.9995% aluminum with 30 ppm Si doping is only partly recrystallized after rolling with a high reduction of 95% (see FIG. 6) in contrast to the fully recrystallized structure formed after similar rolling of a pure material (see FIG. 2). Accordingly, additional annealing of the rolled material at a temperature of 150° C. for about 1 hour is typically desired to obtain a fully recrystallized doped structure. Such results in coarse and non-uniform grains (see FIG. 7).

FIG. 5 illustrates data obtained for 99.9995% aluminum with a 30 ppm silicon dopant. The curve 20 of FIG. 5 conforms to experimental data of 99.9995% aluminum with 30 ppm silicon after rolling with different reductions. A dashed part of the curve 20 corresponds to partial self-recrystallization after rolling, while a solid part of the curve corresponds to full self-recrystallization. The full self-recrystallization is attained after intensive reductions of more than 97%, which are practically not available in commercial target fabrication processes. The point 22 shows the average grain size achieved for the as-deformed material as being about 250 microns, and the point 24 shows that the grain size reduces to about 180 microns after the material is annealed at 150° C. for 1 hour. The points 22 and 24 of FIG. 5 correspond to the structures of FIGS. 6 and 7.

For the reasons discussed above, conventional metal-treatment procedures are incapable of developing the fine grain size and stable microstructures desired in high-purity target materials for utilization in MRAM technologies. For instance, a difficulty exists in that conventional deformation techniques are not generally capable of forming thermally stable grain sizes of less than 150 microns for both doped and non-doped conditions of high-purity metals and metal alloys. Also, particular processing environments can create further problems associated with conventional metal-treatment processes. Specifically, there is a motivation to use cold deformation as much as possible to refine structure, which can remove advantages of hot processing of cast materials for healing pores and voids, and for eliminating other casting defects. Such defects are difficult, if not impossible, to remove by cold deformation, and some of them can even be enlarged during cold deformation. Accordingly, it would be desirable to develop methodologies in which casting defects can be removed, and yet which achieve desired small grain sizes and stable microstructures.

### SUMMARY OF THE INVENTION

In one aspect, the invention encompasses a method of forming a barrier layer. An equal channel angular extruded target is provided and material is ablated from the target to form a layer on a surface of a substrate. The layer has a thickness variance of less than or equal to about 1% of 1-sigma across the surface.

In one aspect the invention encompasses a method of forming a tunnel junction. A first magnetic layer is formed over a substrate. A thin film is formed over the first magnetic layer and a second magnetic layer is formed over the thin film. At least one of the thin film, the first magnetic layer and the second magnetic layer is formed by ablating material from an equal channel angular extrusion target. The resulting layer formed from the ablated material has an improved thickness uniformity relative to a corresponding layer formed utilizing a non-ECAE target under otherwise substantially identical conditions.

In one aspect the invention encompasses a thin film comprising aluminum and having a thickness variance across the thin film of less than 1.5% of 1-sigma standard deviation. The thin film can additionally comprise at least one of Cu, Al, Ga, In, Si, and Zr.

In one aspect the invention encompasses a physical vapor deposition target. The target contains an alloy of aluminum and at least one alloying element selected from Ga, Zr and In. The total amount of the alloying elements present in the target is greater than 1,000 ppm, by weight.

### BRIEF DESCRIPTION OF THE DRAWINGS

Preferred embodiments of the invention are described below with reference to the following accompanying drawings.

FIG. 1 is an optical micrograph of a cast structure of 99.9995% aluminum (magnified 50 times).

FIG. 2 is an optical micrograph of 99.9995% aluminum showing a self-recrystallized structure after 95% cold rolling reduction (magnified 50 times).

FIG. 3 is an optical micrograph of 99.9995% aluminum illustrating a structure achieved after 95% cold rolling reduction and annealing at 150° C. for 1 hour (magnified 50 times).

FIG. 4 is a graph illustrating an effect of prior art rolling reduction processes on grain size of 99.9995% aluminum which is self-recrystallized at room temperature.

FIG. 5 is a graph illustrating the effect of prior art rolling reduction on grain size of a material comprising 99.9995% aluminum with 30 ppm Si, with such material being partly self-recrystallized at room temperature.

FIG. 6 is an optical micrograph of 99.9995% aluminum plus 30 ppm Si after 90% cold rolling reduction (magnified 50 times).

FIG. 7 is an optical micrograph of 99.9995% aluminum plus 30 ppm Si after 90% cold rolling reduction and annealing at 150° C. for 1 hour (magnified 50 times).

FIG. 8 shows a flow chart diagram of a method encompassed by the present invention.

FIG. 9 is an optical micrograph showing the structure of 99.9995% aluminum after 2 passes through an equal channel angular extrusion (ECAE) device (magnified 50 times).

FIG. 10 is an optical micrograph of 99.9995% aluminum after 6 passes through an ECAE device (magnified 50 times).

FIG. 11 is a graph illustrating the effect of ECAE on grain size of 99.9995% aluminum which is self-recrystallized at room temperature.

FIG. 12 is a graph illustrating the effect of ECAE passes on grain size of a material comprising 99.9995% aluminum and 30 ppm Si. The graph illustrates the grain size after self-recrystallization of the material at room temperature.

FIG. 13 is an optical micrograph showing the structure of a material comprising 99.9995% aluminum and 30 ppm Si after 6 passes through an ECAE device (magnified 100 times).

FIG. 14 is an optical micrograph showing the structure of a material comprising 99.9995% aluminum and 30 ppm Si after 6 passes through an ECAE device, 85% cold rolling reduction, and annealing at 150° C. for 16 hours (magnified 100 times).

FIGS. 15A and 15B show optical micrographs of a material comprising aluminum and 10 ppm Sc after 6 ECAE passes via route D (i.e., a route corresponding to billet rotation of 90° into a same direction after each pass through an ECAE device). FIG. 15A shows the material in the as-deformed state and FIG. 15B shows material after 85% rolling reduction in thickness.

FIG. 16 is a diagrammatic sectional view of a semiconductor wafer fragment/section at a preliminary processing step in accordance with an aspect of the invention.

FIG. 17 is view of the FIG. 16 wafer fragment at a processing step subsequent to that shown in FIG. 16.

FIG. 18 is a view of the FIG. 17 wafer fragment at a processing step subsequent to that shown in FIG. 17.

FIG. 19 is a view of the FIG. 18 wafer fragment at a processing step subsequent to that shown in FIG. 18.

FIG. 20 compares the number of particles detected in thin films formed over 200 mm wafers utilizing ECAE targets and non-ECAE targets. The thin films compared were aluminum alloyed with 0.5% copper.

FIG. 21 compares the measured sheet resistance of aluminum plus 0.5% copper thin films formed utilizing ECAE targets and non ECAE targets.

FIG. 22 shows mean reflectivity of a thin film of aluminum alloyed with 0.5% copper formed over 300 mm wafers utilizing ECAE targets.

FIG. 23 shows the uniformity of reflectivity of thin films formed on 300 mm wafers from Al-0.5% copper ECAE targets.

FIG. 24 shows the mean sheet resistance for Al-0.5% copper thin films formed over 300 mm wafers utilizing ECAE targets.

FIG. 25 shows the sheet resistance uniformity for aluminum-0.5% copper thin films formed over 300 mm wafers utilizing an ECAE target.

FIG. 26 shows the measured thickness of aluminum copper thin films formed over a silicon surface of 300 mm wafers utilizing an ECAE target.

FIG. 27 shows the thickness uniformity of aluminum-0.5% copper thin films formed over silicon surface of 300 mm wafers utilizing an ECAE target.

FIG. 28 shows the mean thickness of aluminum copper thin films formed over 300 mm wafers utilizing ECAE targets. The aluminum copper layers were deposited over TEOS derived material.

FIG. 29 shows the thickness uniformity for the aluminum copper layers having the corresponding thickness measurements shown in FIG. 28.

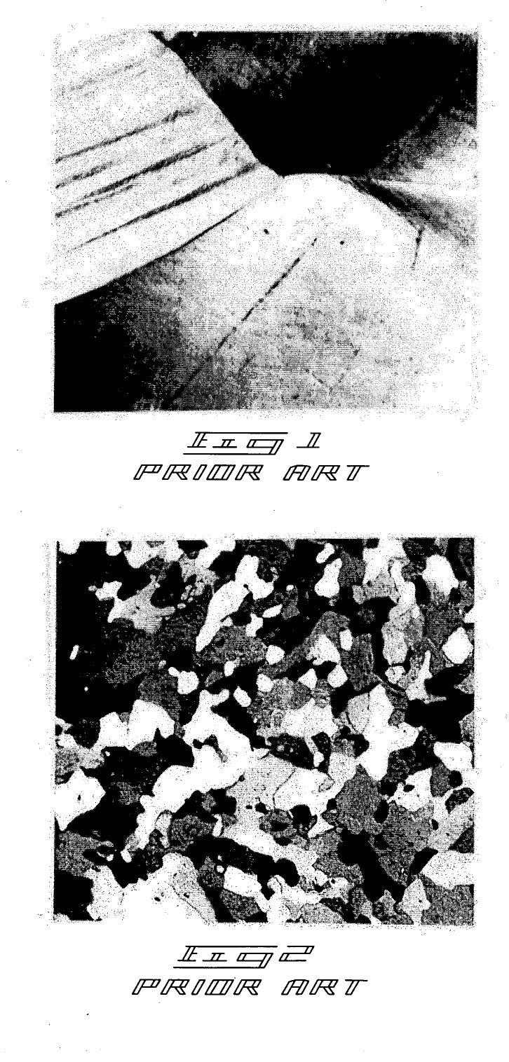

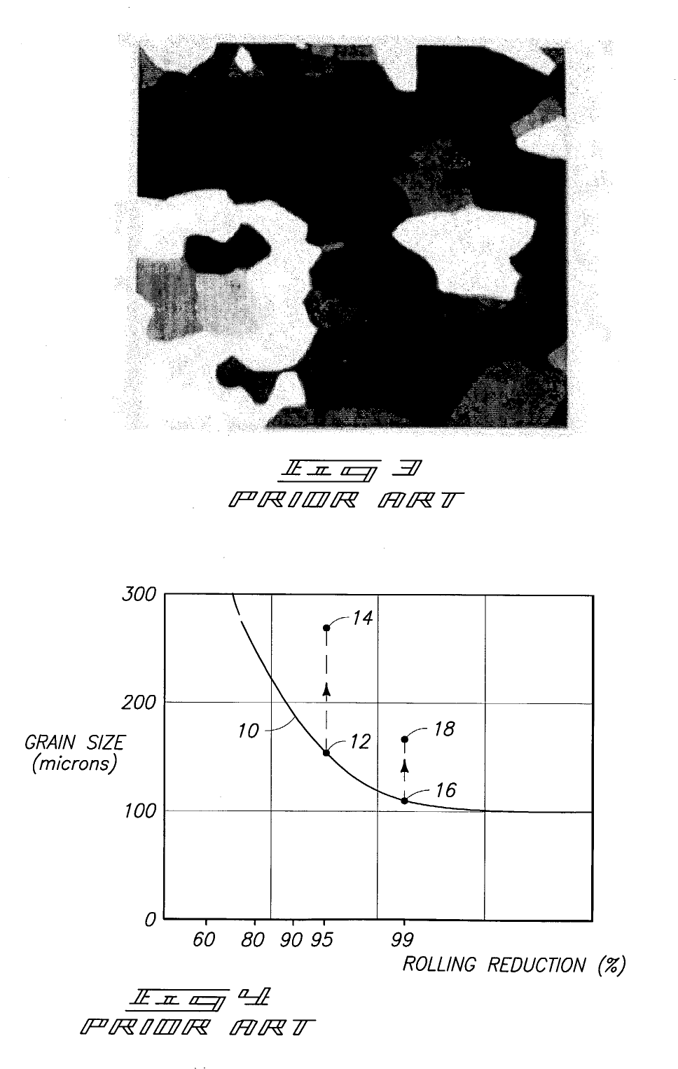

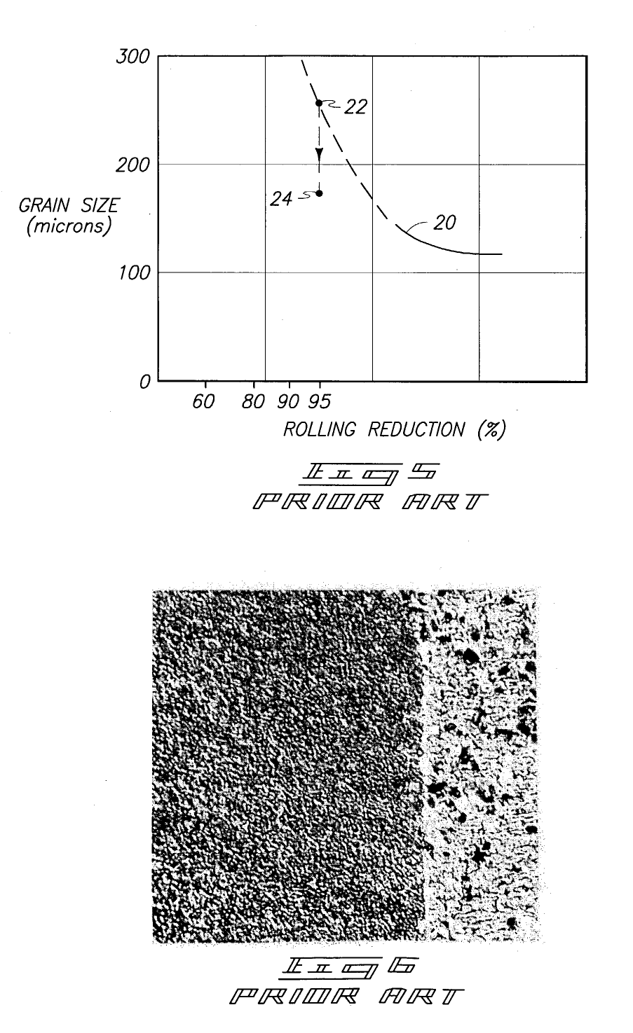

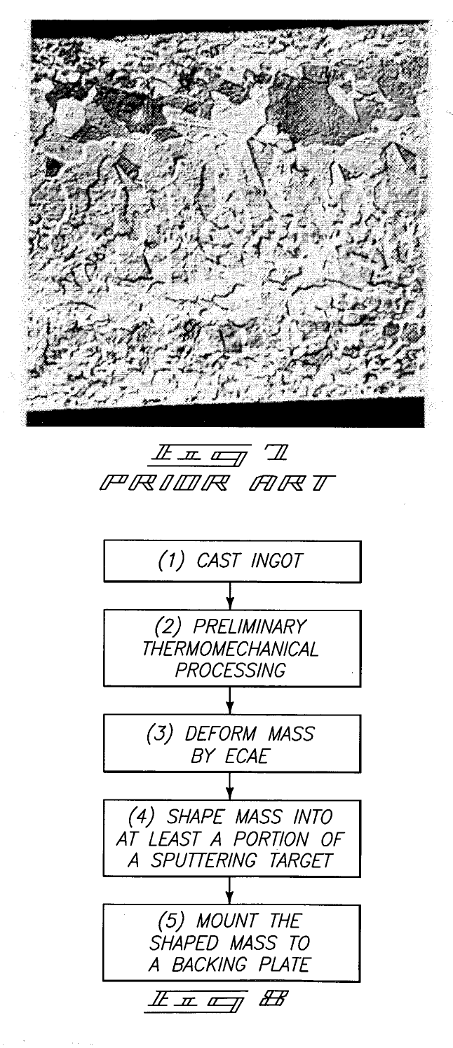

### DETAILED DESCRIPTION OF THE PREFERRED EMBODIMENTS

The invention encompasses thin films having exceptional uniformity of composition and thickness. The thin films of the invention are formed by sputter deposition from targets formed utilizing equal channel angular extrusion (ECAE) processing. The ECAE processing imparts qualities to the resulting targets than enables high quality thin films to be produced. The resulting films have improved thickness uniformity with fewer particles, pinhole defects and impurities relative to films formed from non-ECAE targets.

Films formed utilizing ECAE targets can be particularly useful in applications where uniformity of film thickness can be critical. Such applications include those which require extremely thin films and/or precision uniformity of thickness, resistivity, microstructure and lack of particle defects. An exemplary technology where ECAE targets can be particularly advantageous is in MRAM fabrication. Layers in MRAM devices including but not limited to non-magnetic layers (both conductive and insulative), magnetic layers and anti-magnetic (pinning) layers, can all be sputter-deposited utilizing ECAE targets to impart the desired precision uniformity to the resulting layers or layer stack. The invention encompasses targets and resulting barrier films comprising materials such as high-purity aluminum, and aluminum alloyed with one or more of In, Ga, Zr, Cu, and Si. The invention also encompasses targets and magnetic layers comprising magnetic materials such as those comprising one or more of Ni, Co and Fe. The invention also includes targets and layers comprising anti-magnetic materials, including but not limited to Mn-based materials, where Mn-based refers to a material where Mn is present in a greater abundance than any other single element. Mn-based materials of particular interest include those comprising at least one of Pt, Ir, Fe and Rh. Additionally, the invention encompasses methods of forming any of the layers described above, and methods of forming constructions comprising one or more of the described layers.

Equal channel angular extrusion (ECAE) is a deformation technique that is used with advantage for the manufacture of physical vapor deposition targets, and in particular aspects of the invention is utilized for the first time in the manufacture of targets for MRAM thin film applications. The ECAE technique was developed by V. M. Segal, and is described in U.S. Pat. Nos. 5,400,633; 5,513,512; 5,600,989; and 5,590,390. The disclosure of the aforementioned patents is expressly incorporated herein by reference.

The general principle of ECAE is to utilize two intersecting channels of approximately identical cross section and extrude a billet through the channels to induce deformations within the billet. The intersecting channels are preferably exactly identical in cross-section to the extent that “exactly identical” can be measured and fabricated into an ECAE apparatus. However, the term “approximately identical” is utilized herein to indicate that the cross-sections may be close to exactly identical, instead of exactly identical, due to, for example, limitations in fabrication technology utilized to form the intersecting channels.

An ECAE apparatus induces plastic deformation in a material passed through the apparatus. Plastic deformation is realized by simple shear, layer after layer, in a thin zone at a crossing plane of the intersecting channels of the apparatus. A useful feature of ECAE is that the billet shape and dimensions remain substantially unchanged during processing (with term “substantially unchanged” indicating that the dimensions remain unchanged to the extent that the intersecting channels have exactly identical cross-sections, and further indicating that the channels may not have exactly identical cross-sections).

The ECAE technique can have numerous advantages. Such advantages can include: strictly uniform and homogeneous straining; high deformation per pass; high accumulated strains achieved with multiple passes; different deformation routes, (i.e., changing of billet orientation at each pass of multiple passes can enable creation of various textures and microstructures); and low load and pressure.

ECAE can enable a decrease in the grain size of high-purity aluminum and aluminum alloys used for the manufacture of MRAM by at least a factor of three compared to conventional practices. ECAE can produce similar decreases in grain size for non-magnetic materials such as Cu and Cu-alloys, for magnetic materials such as Ni-alloys and Co-alloys, and for anti-ferromagnetic Mn-based materials relative to grain sizes in these materials produced by conventional practices.

Various aspects of the present invention are significantly different from previous ECAE applications. Among the differences is that the present invention encompasses utilization of ECAE to deform high-purity materials (such as, for example, aluminum having a purity of greater than 99.9995% as desired for particular MRAM applications), in contrast to the metals and alloys that have previously been treated by ECAE. High-purity metals are typically not heat treatable, and ordinary processing steps like homogenizing, solutionizing and aging can be difficult, if not impossible, to satisfactorily apply with high-purity metals. Further, the addition of low concentrations of dopants (i.e., the addition of less than 100 ppm of dopants) doesn't eliminate the difficulties encountered in working with high-purity metals. However, the present invention recognizes that a method for controlling structure of single-phase high-purity materials is a thermo-mechanical treatment by deformation, annealing and recrystallization. Also, as high-purity metals are generally -not stable and cannot be refined by dynamic recrystallization in the same manner as alloys, the present invention recognizes that static recrystallization can be a more appropriate methodology for annealing of high-purity metals than dynamic recrystallization. When utilizing static recrystallization annealing of materials, it is preferred that the static recrystallization be conducted at the lowest temperature which will provide a fine grain size. If strain is increased to a high level within a material, such can reduce a static recrystallization temperature, with high strains leading to materials which can be statically recrystallized at room temperature. Thus, self-recrystallization of the materials can occur immediately after a cold working process. Such can be an optimal mechanism for inducing desired grain sizes, textures, and other microstructures within high-purity metal physical vapor deposition target structures.

In one aspect, the present invention utilizes ECAE to form a physical vapor deposition target for MRAM applications. The target can comprise a body of aluminum with a purity greater than or equal to 99.99% (4N). In particular applications, the target can comprise a high-purity aluminum alloy comprising at least one alloying element selected from In, Ga, Zr, Si and Cu. The aluminum alloy can preferably comprise high-purity aluminum alloyed with from greater than 1000 ppm to about 10%, by weight, and in some instances preferably from greater than 1000 ppm to about 2%, by weight, of the at least one alloying element. Alternatively, an aluminum comprising alloy can comprise greater than 10% of the at least one alloying element.

The invention also encompasses ECAE targets of aluminum comprising alloys having one of. Ga In or Zr as the base element (i.e. being present in greater abundance than any other single element in the material). For example, the aluminum comprising alloy can comprise MₓAl₍₁₋ₓ₎, where x is greater than 0.5 and less than 1, and M is an element selected from In, Zr, and Ga. Preferably, the aluminum comprising alloy has an overall purity of at least 99.99%, meaning at least 99.99% of the alloy composition is the aluminum and the at least one alloying element.

Optionally, the high-purity aluminum or aluminum alloy can be doped with less than or equal to about 1000 ppm of dopant materials. The dopant materials are not considered impurities relative to the doped aluminum or alloy, and accordingly the dopant concentrations are not considered in determining the purity of the aluminum or alloy. In other words, the percent purity of the aluminum (or aluminum alloy) does not factor in any dopant concentrations.

An exemplary target can comprise a body of having a metallic purity greater than or equal to 99.9995%. A total amount of dopant material within the target material is typically between 5 ppm and 1,000 ppm, and more preferably between 10 ppm and 100 ppm. The amount of doping should be at least the minimal amount assuring the stability of material microstructures during sputtering, and less than the minimum amount hindering the completion of full dynamic recrystallization during equal channel angular extrusion.

The dopant materials can, for example, comprise one or more elements selected from the group consisting Ag, Au, B, Ba, Be, C, Ca, Cd, Ce, Co, Cr, Cu, Dy, Er, Ey, Fe, Ga, Gd, Ge, Hf, Ho, In, Ir, La, Lu, Mg, Mn, Mo, Nb, Nd, Ni, P, Pb, Pd, Pm, Pr, Pt, Pu, Re, Ru, S, Sb, Sc, Se, Si, Sm, Sn, Sr, Ta, Tb, Te, Ti, Tm, V, W, Y, Yb, Zn, and Zr. The elements of the dopant materials can be in either elemental or compound form within the materials. The dopant materials can be in the form of precipitates or solid solutions within the aluminum-material matrix. Preferably, the target is composed of aluminum or aluminum alloy with purity greater than or equal to 99.99% (4N), doped with one or more elements from the group listed above.

The present invention can provide a physical vapor deposition target for MRAM applications comprising a body of aluminum or aluminum alloy with purity greater than or equal to 99.99% (4N), alone or doped with less than 1000 ppm of dissimilar elements selected from a group consisting of one or more of Ag, Au, B, Ba, Be, C, Ca, Cd, Ce, Co, Cr, Cu, Dy, Er, Ey, Fe, Ga, Gd, Ge, Hf, Ho, In, Ir, La, Lu, Mg, Mn, Mo, Nb, Nd, Ni, P, Pb, Pd, Pm, Pr, Pt, Pu, Re, Ru, S, Sb, Sc, Se, Si, Sm, Sn, Sr, Ta, Tb, Te, Ti, Tm, V, W, Y, Yb, Zn, and Zr. Further the target can consist of aluminum or aluminum alloy and one or more of the listed dissimilar elements, or can consist essentially of aluminum or aluminum alloy and the one or more of the listed dissimilar elements. The MRAM target can be made of a body of Al or Al-alloy with purity greater than 99.99% (4N), alone or doped with less 100 ppm of one or more dissimilar elements listed above, and the total doping content of any element listed above can be higher than the solubility limit of this element at the temperature at which ECAE is performed.

A preferred MRAM target possesses: a substantially homogeneous composition throughout; a substantial absence of pores, voids, inclusions and any other casting defects; a predominate and controlled grain size of less than about 100 micrometers; and a substantially uniform structure and controlled texture throughout. Preferably, targets in accordance with the methodology of the present invention have an ultra-fine grained microstructure having an average grain size of less than or equal to 50 micrometers, in particular aspects less than or equal to about 10 micrometers, in further aspects less than or equal to about 5 micrometers, in other aspects less than or equal to about 3 micrometers, and in yet further aspects less than or equal to about 1 micrometer. It is to be understood, however, that the invention is not limited to any particular grain size for targets except to the extent that such is explicitly recited in claims. In some instances, very fine and uniform precipitates with average diameters of less than 0.5 micrometers can also be present in a preferred target microstructure.

Desired grain sizes for targets can depend on. at least three characteristics of target material. These characteristics are: 1) The element that forms the major constituent, for example, Al, Cu, Ga, In, Ni, Co, or Mn; 2) The element(s) used to dope or alloy the major constituent; and 3) the concentration of the dopant or alloying element(s). An intended application of a target can also influence the desired grain size of a target material. For instance, targets suitable for conventional Si wafer processing may not be well suited for fabrication of MRAM cells. In MRAM applications, higher purity metals and/or alloys can be desired than are typically utilized in conventional Si-wafer processing. However, Si doping may still be appropriate for targets utilized in MRAM applications. With Si doping of high-purity aluminum, a stable grain size can be about 100 microns if the dopant concentration is low (several ppm). This is actually a larger grain size than in conventional Al-0.5%Cu, but is a substantial improvement over the conventionally prepared pure (or nearly pure) Al targets. ECAE targets can provide improved layer thickness uniformity, resistivity uniformity and composition uniformity relative to non-ECAE targets even where the ECAE target grain size is larger than 10 microns or even greater than 100 microns.

Physical vapor deposition targets of the present invention can be formed from a cast ingot comprising, consisting of, or consisting essentially of aluminum, aluminum alloy, a magnetic material or anti-magnetic material as described above. The ingot material can be extruded through a die possessing two contiguous channels of equal cross section intersecting, each other at a certain angle. The ingot material can also be subjected to annealing and/or processing with conventional target-forming processes such as rolling, cross rolling or forging, and ultimately fabricated into a physical vapor deposition target shape. The extrusion step can be repeated several times via different deformation routes before final annealing, conventional processing and fabrication steps to produce very fine and uniform, grain sizes within a processed material, as well as to control texture strength and orientation within the material.

Processes of the present invention can be applied to form monolithic targets or targets comprised of two or more segments.

Particular embodiments of the present invention pertain to formation of aluminum comprising physical vapor deposition targets, such as, for example, formation of aluminum comprising physical vapor deposition targets suitable for tunneling barrier applications. FIG. 8 shows a flow-chart diagram of an exemplary target fabrication process of the present invention. In a first step, an aluminum-comprising cast ingot is formed, and in a second step the ingot is subjected to thermo-mechanical processing. The material resulting from the thermo-mechanical processing is an aluminum-comprising mass. The mass is subsequently deformed by equal channel angular extrusion (ECAE). Such deformation can be accomplished by one or more passes through an ECAE apparatus. Exemplary ECAE apparatuses are described in U.S. Pat. Nos. 5,400,633; 5,513,512; 5,600,989; and 5,590,390.

The aluminum-comprising mass can consist of aluminum or aluminum alloyed with one or more of In, Ga, Si, Cu, and Zr. In particular aspects, the aluminum-comprising mass can consist essentially of aluminum or aluminum alloy. The mass preferably comprises at least 99.99% pure aluminum or aluminum alloy. The mass can further comprise less than or equal to about 100 parts per million (ppm) of one or more dopant materials comprising elements selected from the group consisting of Ag, Au, B, Ba, Be, C, Ca, Cd, Ce, Co, Cr, Cu, Dy, Er, Ey, Fe, Ga, Gd, Ge, Hf, Ho, In, Ir, La, Lu, Mg, Mn, Mo, Nb, Nd, Ni, P, Pb, Pd, Pm, Pr, Pt, Pu, Re, Ru, S, Sb, Sc, Se, Si, Sm, Sn, Sr, Ta, Tb, Te, Ti, Tm, V, W, Y, Yb, Zn, and Zr. The aluminum comprising mass can consist of aluminum or Al-alloy, with less than or equal to about 100 ppm of one or more of the dopant materials described above, or consist essentially of aluminum or Al-alloy, with less than or equal to about 100 ppm of one or more of the dopant materials described above.

The described ECAE processing can also be utilized to form targets of the non-aluminum based aluminum-comprising alloy materials set forth above. The aluminum-comprising alloy material can be doped or undoped. As further indicated above, the target grain size can be influenced by the base element (Al, Ga, In, Zr, Cu), as well as the amount and type of alloying element(s) and/or dopant elements present in the alloy material.

ECAE is utilized in methodology of the present invention for addressing problems found during formation of PVD targets of high-purity materials. ECAE is a process which utilizes a simple shear deformation mode, which is different from a dominant deformation mode achieved by uniaxial compression of forging or rolling. In high-purity metals, the intensive simple shear of ECAE can manifest itself by developing very thin and long shear bands. The strains achieved inside these bands can be many times larger than the strains achieved outside the bands. The shear bands occur along a crossing plane of the channels utilized during ECAE. If a processing speed is sufficiently low to eliminate adiabatic heating and flow localization at the macro-scale, shear bands in pure metals can have a thickness of only a few microns with a near regular spacing between each other of a few tenths of a micron. The bands can be observed after a single ECAE pass. However, if the number of ECAE passes increases the spacing between shear bands can reduce to a stable size. The actual size can vary depending on the material being subjected to ECAE, and the purity of such material. A strain inside of the shear bands can be equivalent to very high reductions (specifically, reductions of about 99.99% or more), and static recrystallization is immediately developed in the bands. The static recrystallization can lead to new fine grains growing in spacing between the bands.

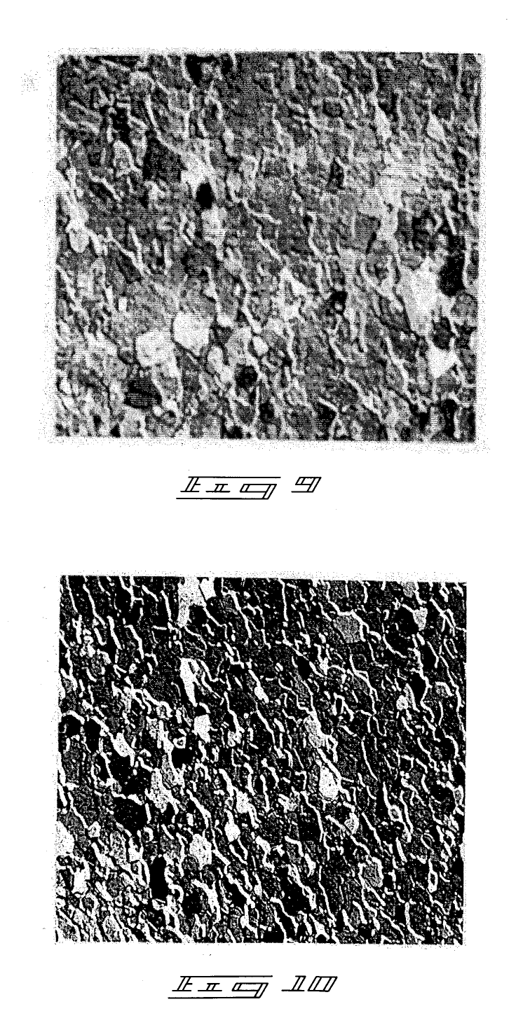

FIGS. 9 and 10 show fully recrystallized structures of 99.9995% aluminum after ECAE with 2 passes and 6 passes, respectively. The grains within the material attained a stable size after 6 passes. Experiments have shown that processing with a route corresponding to billet rotation of 90° into a same direction after each pass can provide the most uniform and equiaxial recrystallized structures for high-purity materials. Such route is defined as route “D” in accordance with the standard definitions that have been utilized to describe ECAE processing in previous publications.

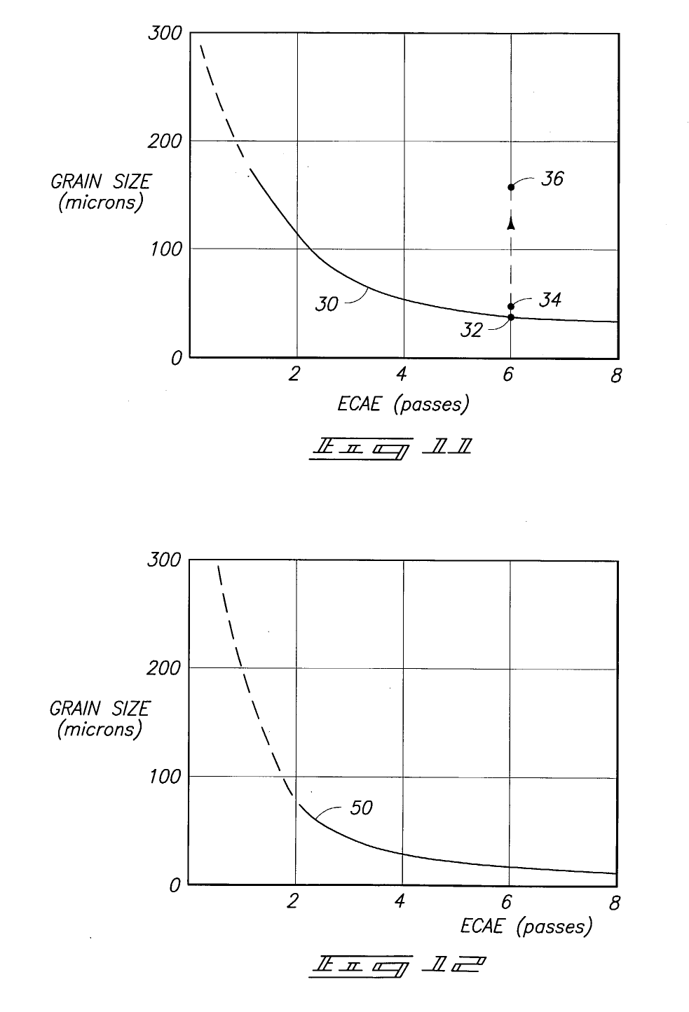

FIG. 11 shows a curve 30 demonstrating the change manifested in grain size of a high-purity aluminum material subjected to varying numbers of ECAE passes. Curve 30 of FIG. 11 can be compared with the curve 10 of FIG. 4 to illustrate advantages in grain size reductions attained by an ECAE process relative to the conventional processes utilized to generate the curve 10 of FIG. 4. The ECAE structures are found to not only have small grain sizes, but also to be stable during additional annealing to sputtering-type temperatures. For example, after annealing at 150° C. for 1 hour, a material subjected to six ECAE passes shows only a relatively insignificant increase in grain size of from 40 microns (point 32 in FIG. 11) to 50 microns (point 34 in FIG. 11).

One method which can be utilized to avoid grain size growth within ECAE processed materials is to provide doping elements within the ECAE materials. However, while the, addition of dopants can typically be utilized for structure refinement when static recrystallization is performed as a separate annealing operation at sufficiently high temperatures after mechanical working, it cannot generally be applied in the case of self-annealing at room temperature during or immediately after deformation performed by forging or rolling because the doping can make even heavily deformed structures more stable.

ECAE can be utilized for grain refinement of high-purity metals, even if the metals have some dopant material therein. For instance, 99.9995% aluminum having 30 ppm of silicon therein is found to be almost fully recrystallized after 2 passes through an ECAE apparatus. If the material is subjected to 3 to 6 passes through the apparatus, it is found to have a fine and uniform structure, with such structure remaining substantially unchanged after 6 passes through the device. FIG. 12 illustrates a curve 50 corresponding to the change in grain size of 99.9995% aluminum having 30 ppm silicon therein, with various numbers of ECAE passes. A dashed part of curve 50 corresponds to partial recrystallization, and a solid part of curve 50 corresponds to full recrystallization at room temperature immediately after ECAE.

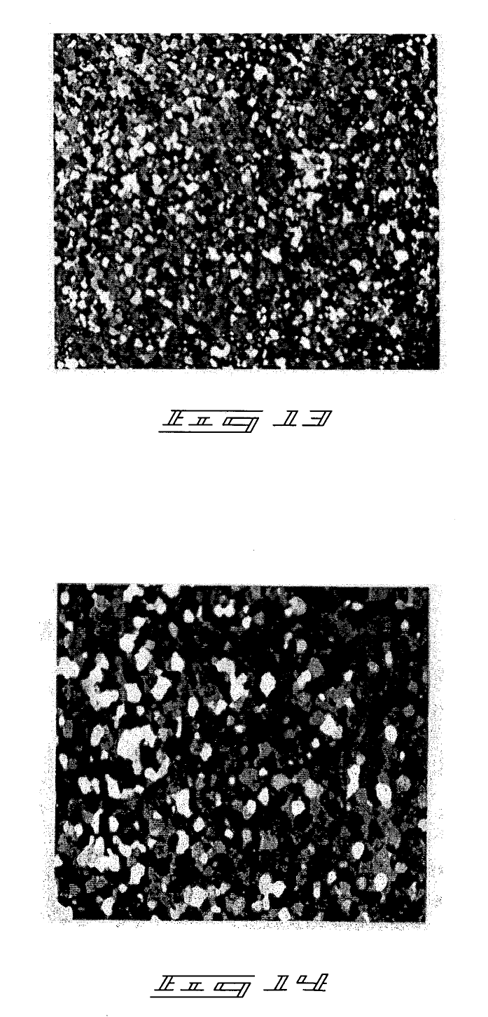

The structure after 6 passes is illustrated in FIG. 13. Such structure is a substantially perfectly recrystallized, uniform, very fine and equiaxial structure having an average grain size of about 15 microns. Such properties can provide exceptional stability of the structure during subsequent rolling and annealing. For instance, subsequent rolling with a reduction of up to 90%, and long-term annealing of about 16 hours at a temperature of 150° C. causes only a moderate grain growth, with the resulting structure having an average grain size of about 30 microns. Further, structure uniformity is maintained, as illustrated in the optical micrograph of FIG. 14. Such stability of the small grain size microstructures achieved with ECAE is substantially different than what can be accomplished with conventional processes of forging, rolling or other deformation techniques. Accordingly, ECAE can provide improved methodology for fabricating high-purity targets with fine and stable microstructures for physical vapor deposition applications. It is found that ECAE processing utilizing from 3 to 6 passes through an ECAE device is typically suitable for forming a physical vapor deposition target blank. In particular, ECAE with 4 passes of route “D” (i.e., rotation of 90° into the same direction after each pass) can be an optimal processing schedule.

Among the benefits of utilizing ECAE for forming target blanks of high-purity materials, relative to utilizing conventional processes, is that ECAE can be utilized in combination with a hot-forging operation. Specifically, ECAE removes restrictions on attainable deformation during processing from a cast ingot to a target blank, and accordingly removes requirements on the original structures subjected to ECAE. A material can be subjected to hot forging prior to ECAE. Such hot forging can result in substantially entire elimination of casting defects, which can further result in improved performance of targets formed by methodology of the present invention relative to targets formed by conventional processes.

In a fourth step of the FIG. 8 flow-chart diagram, the deformed mass is shaped into a PVD target, or at least a portion of a target. Such shaping can comprise, for example, one or more of rolling, cross rolling, forging, and cutting of the mass. The mass can be formed into a shape comprising an entirety of a physical vapor deposition target, or alternatively can be formed into a shape comprising only a portion of a physical vapor deposition target. An exemplary application wherein the mass is formed into a shape comprising only a portion of a physical vapor deposition target is an application in which the mass is utilized to form part of a so-called mosaic target.

In the fifth step of the FIG. 8 process, the shaped mass can be mounted to a backing plate to incorporate the mass into a target structure. Suitable backing plates and methodologies for mounting targets to backing plates are known in the art. It is noted that the invention encompasses embodiments wherein a processed mass is utilized directly as a physical vapor deposition target without being first mounted to a backing plate, as well as embodiments in which the mass is mounted to a backing plate.

The processes of the present invention described above can be utilized to fabricate aluminum-comprising masses into targets having very fine and homogenous grain structures, with predominate sizes of the grains being less than about 100 micrometers. Such targets can be particularly suitable for sputtering applications in forming MRAM tunneling barrier materials. The described processing can also be utilized in forming targets for ferromagnetic layer materials, anti-ferromagnetic layer materials and conductive non-magnetic layer materials as well. The present invention recognizes that improvements in grain refinement can be provided by ECAE technology relative to conventional processing of aluminum-comprising and other non-magnetic materials, magnetic materials, and anti-magnetic materials. The ECAE is preferably conducted at a temperature and speed sufficient to achieve desired microstructures and provide a uniform stress strain state throughout a processed billet.

The number of passes through an ECAE device, and the particular ECAE deformation route selected for travel through the device can be chosen to optimize target microstructures. For instance, grain refinement can be a consequence of radical structural transformations occurring during intense straining by simple shear through an ECAE device.

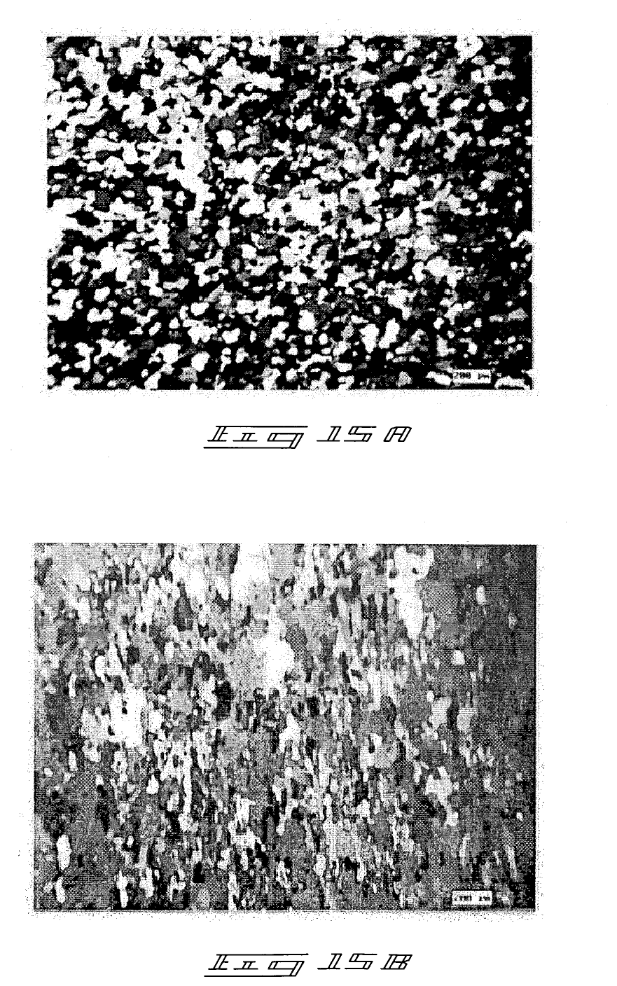

FIGS. 15A and 15B illustrate grains obtained for aluminum+10 ppm Sc after ECAE processing. The grains shown in FIG. 15A have an average size of about 20 microns, and are relatively fine, equiaxial, and homogenous. The structure shown in FIG. 15A has an average grain size that is at least a factor of 3 smaller than the sizes produced by conventional target forming methods.

At least three different aspects of ECAE contribute to the remarkable reduction of grain size and improvement of grain uniformity achieved by treating materials in accordance with the present invention. These three aspects are an amount of plastic deformation imparted by ECAE, the ECAE deformation route, and simple shear forces occurring during ECAE.

After a material has been subjected to ECAE in accordance with methods of the present invention, the material can be shaped by conventional methods of forging, cross rolling and rolling to form the material into a suitable shape to be utilized as a target in a sputtering process. The ultrafine grain sizes created during ECAE are found to remain stable and uniform, and to show limited grain growth upon further conventional processing; even during processing comprising a high reduction in thickness of a material. Such is exemplified by FIG. 15, which compares various microstructures of as-deformed ECAE samples (FIG. 15A) to those submitted to further unidirectional rolling at an 85% thickness reduction (FIG. 15B) for aluminum+10 ppm Sc.

Preferably, traditional forming operations utilized for shaping a material after ECAE processing are conducted at temperatures which are less than those which will occur during sputtering. For instance, if sputtering processes are anticipated to occur at about 150° C., then conventional processing of, for example, rolling, cross rolling, or forging occurring after ECAE will preferably occur at temperatures below 150° C. As will be recognized by those skilled in the art, the sputtering conditions such as temperature can depend upon a variety of factors including the composition of the target. By conducting such processing at temperatures below the sputtering temperature, the likelihood of the conventional processing increasing grain sizes beyond those desired in a physical vapor deposition target is reduced. Typically, target shaping steps occur at temperatures of less than or equal to about 200° C., and more preferably occur at temperatures less than or equal to about 150° C., to keep the target shaping steps at temperatures below an ultimate sputtering temperature of a target.

The microstructures created during ECAE are found to exhibit exceptional stability upon annealing relative to microstructures created by conventional processes. For example, it is found that a sample of aluminum+30 ppm Si which has been subjected to ECAE shows a limited and progressive increase in average grain size from approximately 12 microns to about 30 microns after annealing at 150° C. for 1 hour. Such average grain size does not significantly change after annealing at 150° C. for 16 hours. In contrast, samples submitted solely to rolling to an 85% reduction in thickness (a conventional process) show a dramatic grain growth up to average grain sizes larger than 250 micron after annealing at only 125° C. for 1 hour.

Utilization of ECAE for processing targets can enable control of a texture within the targets, with the term “texture” referring to a crystallographic orientation within the target. If a large number (i.e. a vast majority) of the grains in a material have the same crystallographic orientation as one another, the material is referred to as having strong texture. In contrast, if the grains do not have the same crystallographic orientation, the material is referred to as having a weak texture. Note that the referred to crystallographic orientation is not to imply that the grains are part of a single crystal. Various textures can be created utilizing methodology of the present invention.

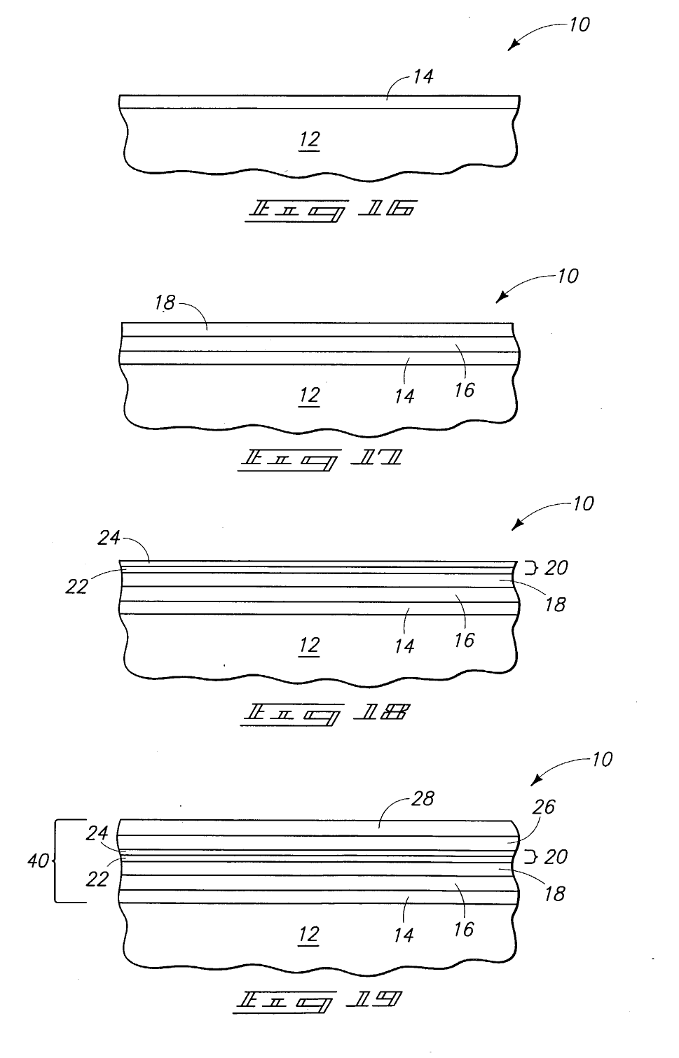

The ECAE targets described above can be utilized in accordance with the present invention to form layers, thin films, thin film stacks, and in particular instances, MRAM circuitry. An exemplary embodiment of forming layers according to an aspect of the invention is described with reference to FIGS. 16-19. FIG. 16 depicts a wafer fragment 10 comprising a substrate 12. Substrate 12 can comprise for example, a bulk monocrystalline silicon substrate. In the context of this description, the term “semiconductor substrate” or “semiconductive substrate” is defined to mean any construction comprising semiconductive material including, but not limited to, bulk semiconductive materials such as a semiconductive wafer (either alone or in assemblies comprising other materials thereon), semiconductive material layers (either alone or in assemblies comprising other materials). The term “substrate” refers to any supporting structure, including but not limited to the semiconductive substrate described above. Also in the context of this document, the term “layer” encompasses both the singular and the plural unless otherwise indicated. A bottom electrode layer 14 can be formed over substrate 12 by depositing an appropriate electrode material.

Referring to FIG. 17, an anti-ferromagnetic layer 16 can be formed over electrode 14. In particular applications, anti-magnetic layer 16 can be referred to as a pinning layer where such layer can orient and/or fix the magnetic vector of an overlying magnetic layer. Anti-ferromagnetic layer 16 can comprise, for example, a manganese-based material such as the manganese-based materials described above. In particular instances, pinning layer 16 can consist essentially of any of the described Mn-based materials. Anti-ferromagnetic layer 16 can be formed for example, by sputter deposition utilizing an ECAE target comprising anti-ferromagnetic material described above.

Anti-ferromagnetic layer 16 is not limited to a specific thickness. Additionally, layer 16 can comprise a single deposited layer or can include multiple layers (not shown) of anti-ferromagnetic material. Generally, anti-ferromagnetic layer 16 will have a thickness of less than about 100 nm, typically less than 50 nm. In some instances, layer 16 can preferably be less than 20 nm and in particular applications can preferably be less than or equal to about 10 nm. Pinning layer 16 can preferably have a grain size of about 10 μm, and in some applications less than or equal to about 5 μm. As will be understood by those skilled in the art, formation of anti-ferromagnetic layer 16 can include post deposition processing steps such as, for example, annealing.

A first magnetic layer 18 can be deposited over pinning layer 16. Magnetic layer 18 can comprise a magnetic or ferromagnetic material such as those described above with respect to target materials. In particular applications, layer 18 can consist essentially of any of the described magnetic materials. Magnetic material 18 can be deposited by, for example, sputter deposition utilizing an ECAE target. Utilization of an ECAE target for formation of magnetic layer 18 can impart superior thin film properties such as improved thickness uniformity relative to use of non-ECAE targets. Magnetic thin film 18 formed in accordance with methodology of the present invention can have a thickness variance of less than about 1.5% of 1-sigma (standard deviation), and in particular instances less than about 1% of 1-sigma across the entire surface of the deposited layer. Further improvements that can occur utilizing an ECAE target include an absence of detectible particle defects, an absence of detectible voids and pinholes, and a substantially uniform composition and microstructure throughout magnetic layer 18.

Although, FIG. 17 depicts layer 18 as a single layer, it is to be understood that layer 18 can comprise multiple magnetic layers (not shown). An overall thickness of magnetic layer 18 is not limited to a particular value and can be, for example, less than or equal to about 100 nm, preferably less than or equal to 50 nm, more preferably less than or equal to about 10 nm. In particular instances, for example, MRAM applications having submicron cell sizes it can be desirable for pinned magnetic layer 18 to have a thickness of less than or equal to about 50 angstroms.

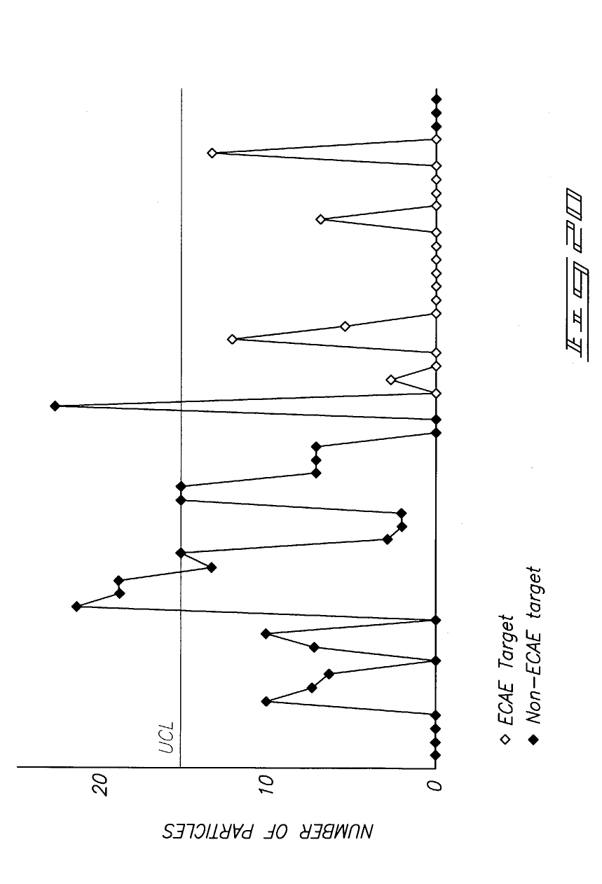

Referring to FIG. 18, a non-magnetic layer 20 can be formed over magnetic layer 18 utilizing, for example, sputtering deposition from an ECAE target. Layer 20 can comprise a conductive material or an insulative material, depending upon the particular application. In tunnel junction applications, layer 20 can serve as a tunneling barrier and can preferably comprise an oxide material such as aluminum oxide; an oxide of Ga, In, or Zr; an oxide of an alloy comprising one or more of Al, Ga, In, Zr, and Si; or mixtures thereof. For spin-valve applications, layer 20 can comprise a conductive material such as a copper-comprising material or high-purity copper. As depicted in FIG. 18, layer 20 can comprise two sub-layers 22 and 24. Layers 22 and 24 can comprise substantially identical materials or can comprise different metal oxides. In MTJ applications, layers 22 and 24 can individually comprise, for example, aluminum oxide, oxide of an aluminum-comprising alloy or an oxide of a metal selected from the group consisting of Ga, Zr, In or mixtures thereof. Alternatively, layer 20 can comprises a single layer of material (not shown).

Formation of layer 20 can: comprise, for example, deposition of one or more metallic materials by sputter deposition from an ECAE target followed by oxidation of the deposited material. As deposited, layer 20 can, in particular aspects, consist essentially of the target material. For example, layer 20 can consist essentially of aluminum, can consist essentially of aluminum alloyed with gallium, or can consist essentially of aluminum alloyed with indium. Where layer 20 comprises two or more sublayers 22 and 24, a lower portion 22 can be deposited and can be oxidized prior to depositing upper portion 24. Alternatively, sputter deposition of both layer 22 and 24 can occur prior to any oxidation and can be followed by an oxidation step to partially or fully oxidize layers 22 and 24.

In an alternative embodiment, layer 20 can be oxidized during deposition. In another aspect, layer 20 can comprise a nitride material having nitrogen incorporated during or subsequent to deposition.

Formation of layer 20 utilizing one or more ECAE targets can provide for precision deposition which can impart improved thickness uniformity and resistivity uniformity to layer 20 relative to a corresponding layer formed utilizing a non ECAE target under otherwise identical deposition conditions. For example, layer 20 can have a thickness uniformity of less than or equal to about 1.5% of 1-sigma standard deviation. In particular instances, layer 20 can have a thickness deviation of less than or equal to about 1% of 1-sigma.

The thickness of layer 20 is not limited to a particular value and can be, for example, less than or equal to about 100 nm, preferably less than or equal to about 50 nm. In some MRAM applications, layer 20 can preferably comprise a thickness of less than or equal to 10 nm, preferably less than or equal to 5 nm or preferably less than or equal to 3 nm. Where an MRAM device will comprise a submicron cell size, layer 20 can preferably have a thickness of less than or equal to about 2 microns, and in particular instances less than 1 micron. One advantage of forming layer 20 utilizing an ECAE sputtering target is to uniformly fine grain size of the layer. For example, aluminum-comprising layers formed by ablating from an ECAE target can have an average grain size of less or equal to less than or equal to about 10 micrometers, in some instances can have an average grain size of less than or equal to about 5 micrometers, and in particular instances less than or equal to about 1 micrometer. Average grain sizes for film 20 comprising non-aluminum based materials comprising one or more of Ga, In, Zr, and Si can also be less than or equal to about 20 micrometers, and preferably less than or equal to about 5 μm. It is noted however that films formed in accordance with the invention can be amorphous rather than polycrystalline.

Sputtering targets utilized for formation of layer 20 can include one or more of the non-magnetic material sputtering targets discussed above. The sputtering targets utilized for formation of layer 20 can be doped or undoped. In addition to having improved uniformity of thickness, microstructure and resistivity relative to films form using non-ECAE targets, the films of the present invention can additionally have an absence of detectible pinholes, deposited particles and/or voids.

Referring to FIG. 19, a second magnetic layer 26 can be formed over layer 20. In particular applications, magnetic layer 26 can be referred to as a free magnetic layer, where the term “free” indicates that the magnetic vector of the layer is not pinned or fixed by a pinning layer. Magnetic layer 26 can comprise any of the magnetic materials indicated above with respect to first magnetic layer 18. First and second magnetic layers 18 and 26 can be a same composition or can alternatively comprise differing compositions. A top electrode 28 can be deposited over second magnetic layer 26. Top electrode 28 can comprise an appropriate electrode material which can be the same as or differ from the material comprised by bottom electrode 14.

Layers 14, 16, 18, 20, 26 and 28 can be collectively referred to as a stack or thin film stack 40. Although each of layers 16, 18 and 26 are described above as being formed utilizing an ECAE target, one or more of the layers comprised by stack 40 can alternatively be formed utilizing alternative deposition methods or non-ECAE target(s). It is to be understood that the invention encompasses alternative stack structures from stack 40 shown in FIG. 19. For example, invention encompasses alternative embodiments anti-ferromagnetic layer 16 is omitted or where an anti-ferromagnetic layer is disposed between non-magnetic layer 26 and electrode 28. Further, the invention contemplates stack structures having more than one anti-ferromagnetic layer, more than one non-magnetic layer, and/or additional magnetic layers (not shown). It is also to be understood that thin film stack 40 over substrate 12 in FIG. 19 can optionally undergo further processing.

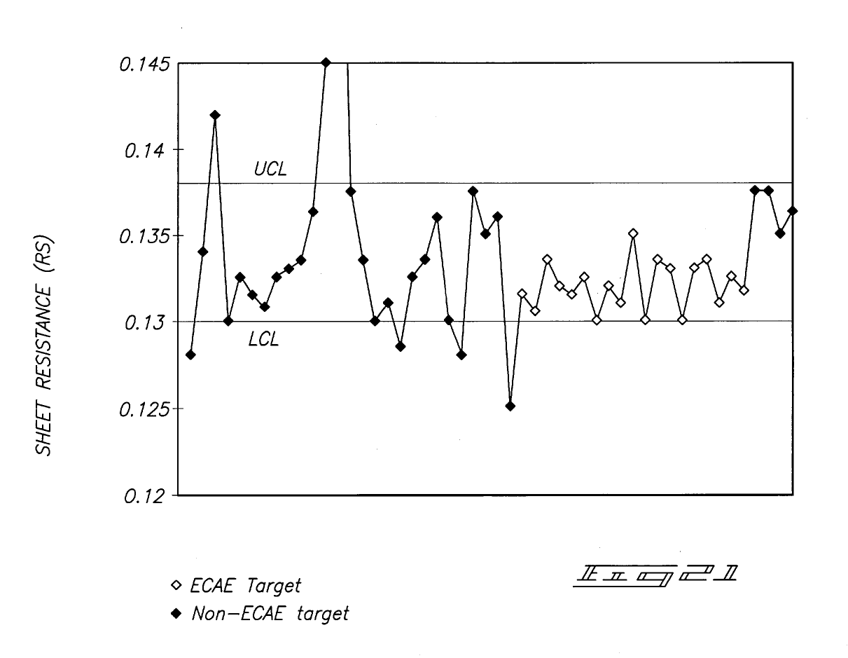

Referring to FIG. 20, such shows a comparison between thin films formed utilizing an ECAE target and a non-ECAE target. As indicated in FIG. 20, very few if any particles are detected in films formed utilizing an ECAE target relative to films formed utilizing other targets. Films formed with ECAE targets have consistently fewer particles deposited therein, typically averaging 2-3 times fewer particles relative to films form with alternative targets, and are consistently below the upper control limit (UCL) for particle deposition. Referring to FIG. 21, such compares the measured sheet resistance for films formed utilizing an ECAE target relative to films formed utilizing non-ECAE targets under otherwise identical deposition conditions. As shown in FIG. 21, ECAE deposition provides improved wafer-to-wafer repeatability in sheet resistance.

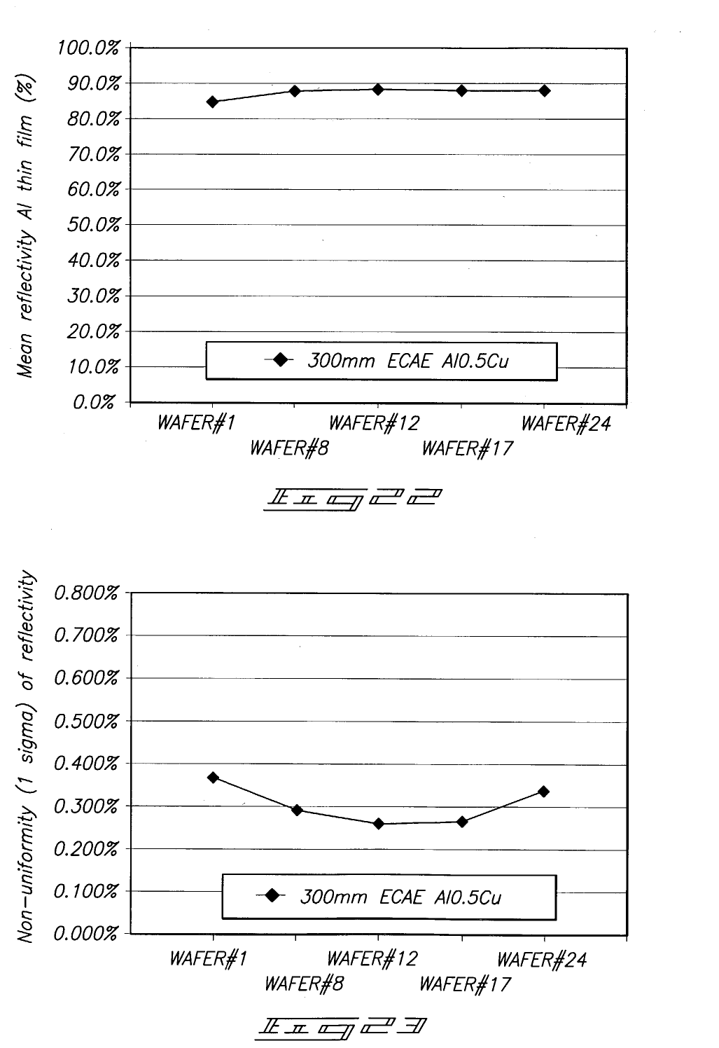

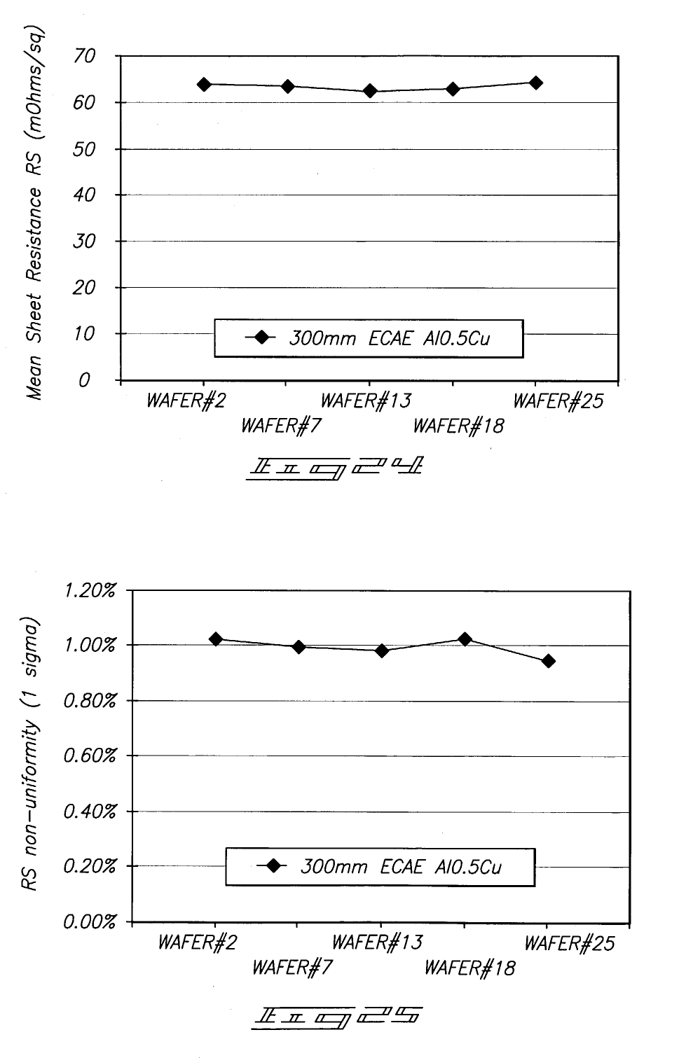

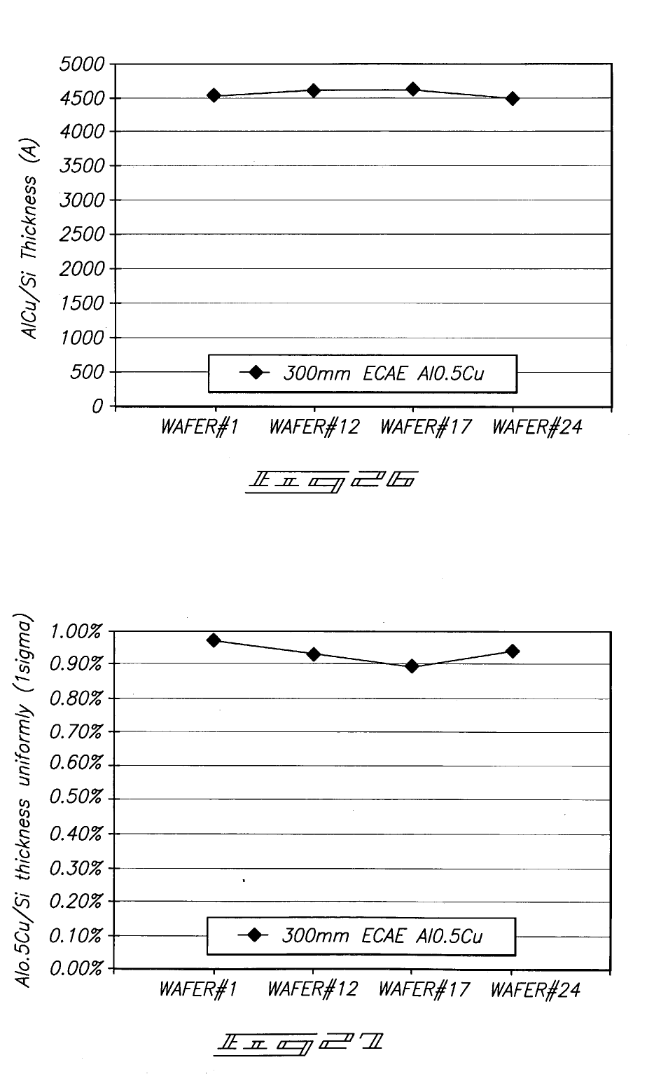

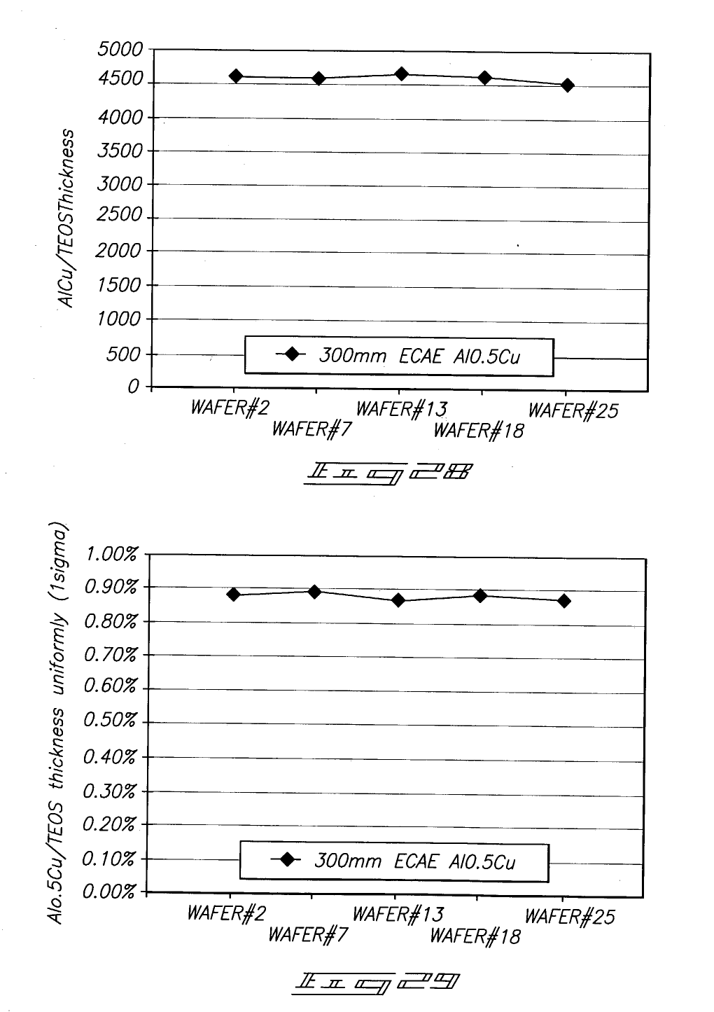

FIGS. 22-29 show measured properties of films formed utilizing ECAE targets having a composition of aluminum and 0.5% copper. Each data point on each graph in FIGS. 22-29 represents the mean value of approximately 49 measurements of a layer formed across a 300 mm wafer. FIGS. 22 and 23 indicate highly uniform reflectivity in the resulting layers. FIGS. 24 and 25 show the extreme uniformity of resistivity in the resulting layers. FIGS. 26-29 show the extreme uniformity in thickness for the resulting layers.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of forming a barrier layer comprising:
providing an equal channel angular extruded target;
providing a substrate having a surface; and
ablating material from the target to form a layer over the surface, the layer having a thickness that varies less than or equal to about 1% of 1-sigma across the surface.

2. The method of claim 1 wherein the substrate is a 200 mm wafer.

3. The method of claim 1 wherein the substrate is a 300 mm wafer.

4. The method of claim 1 wherein the layer is deposited over a magnetic layer.

5. The method of claim 1 wherein the layer comprises aluminum.

6. The method of claim 1 wherein the layer comprises an aluminum alloy containing at least one alloying element selected from the group consisting of In, Ga and Si.

7. The method of claim 1 wherein the layer comprises Ga.

8. The method of claim 1 wherein the layer comprises In.

9. The method of claim 1 further comprising oxidizing the layer after the ablating to form an oxidized layer.

10. The method of claim 9 wherein the oxidized layer comprises a thickness that deviates less than or equal to about 1% of 1-sigma.

11. The method of claim 9 wherein the oxidized layer has a thickness of less than or equal to about 100 nm.

12. The method of claim 9 wherein the oxidized layer has a thickness of less than or equal to about 10 nm.

13. The method of claim 9 wherein the oxidized layer has a thickness of less than or equal to about 1.0 nm.

14. A method of forming a magnetic tunnel junction comprising:
providing a substrate having a first magnetic layer thereon;
ablating material from an equal channel angular extrusion (ECAE) target to form a thin film over a surface of the first magnetic layer, the thin film having an resistance-area (RA) uniformity of less than or equal to about 1% of 1-sigma standard deviation across the surface; and
depositing a second magnetic layer over the thin film.

15. The method of claim 14 further comprising oxidizing the thin film to form a tunneling barrier oxide layer.

16. The method of claim 14 wherein the first magnetic layer is a fixed ferromagnetic layer.

17. The method of claim 14 wherein the second magnetic layer is a free ferromagnetic layer.

18. The method of claim 14 wherein the ECAE target comprises doped aluminum having at least one dopant element selected from the group consisting of Ag, Au, B, Ba, Be, C, Ca, Cd, Ce, Co, Cr, Cu, Dy, Er, Ey, Fe, Ga, Gd, Ge, Hf, Ho, In, Ir, La, Lu, Mg, Mn, Mo, Nb, Nd, Ni, P, Pb, Pd, Pm, Pr, Pt, Pu, Re, Ru, S, Sb, Sc, Se, Si, Sm, Sn, Sr, Ta, Tb, Te, Ti, Tm, V, W, Y, Yb, Zn, and Zr.

19. The method of claim 14 wherein the thin film comprises an aluminum alloy containing at least one alloying element selected from the group consisting of Ga and In.

20. A method of forming a tunnel junction comprising:
providing a substrate;
forming a first magnetic layer over the substrate;
forming a thin film over the first magnetic layer; and
forming a second magnetic layer over the thin film, at least one layer selected from the first magnetic layer, the thin film and the second magnetic layer being formed by a method comprising ablating material from an equal channel angular extrusion (ECAE) target, the at least one layer having an improved thickness uniformity relative to a corresponding layer formed utilizing a non-ECAE target under otherwise substantially identical conditions.

21. The method of claim 20 wherein the at least one layer has a layer thickness non-uniformity of less than or equal to about 1% of 1-sigma.

22. The method of claim 20 wherein the at least one layer is the first magnetic layer, and wherein the ECAE target comprises at least one of a nickel alloy and a cobalt alloy.

23. The method of claim 20 wherein the at least one layer is the second magnetic layer, and wherein the ECAE target comprises at least one of a nickel alloy and a cobalt alloy.

24. The method of claim 20 wherein the at least one layer is the thin film, and wherein the ECAE target comprises an aluminum alloy.

25. The method of claim 20 further comprising, prior to forming the first magnetic layer, depositing an anti-ferromagnetic layer.

26. The method of claim 25 wherein the anti-ferromagnetic layer comprises an Mn-based material. and wherein the depositing comprises sputtering material from an ECAE target to form the anti-ferromagnetic layer to have a thickness variance of less than about 1% of 1-sigma.

27. The method of claim 20 wherein the at least one layer has a thickness of less than about 10 nm.

28. The method of claim 20 wherein the at least one layer has a thickness of less than about 1.0 nm.

29. The method of claim 20 wherein the at least one layer has an average grain size of less than or equal to about 10 microns.

30. The method of claim 20 wherein the at least one layer has an average grain size of less than or equal to about 5 microns.

31. The method of claim 20 wherein the at least one layer has an average grain size of less than or equal to about 1 micron.

32. The method of claim 20 wherein the forming the thin film comprises depositing a first material having a first thickness and depositing a second material having a second thickness over-the first material.

33. The method of claim 32 further comprising oxidizing at least one of the first material and the second material.

34. The method of claim 32 wherein the first material comprises aluminum and the second material comprises at least one of Cu, Al, Ga, In, Si, and Zr.

35. The method of claim 32 wherein the second material comprises aluminum and the first material comprises at least one of Cu, Al, Ga, In, Si, and Zr.

36. A thin film comprising:
aluminum;
at least one of Ag, Au, B, Ba, Be, C, Ca, Cd, Ce, Co, Cr, Cu, Dy, Er, Ey, Fe, Ga, Gd, Ge, Hf, Ho, In, Ir, La, Lu, Mg, Mn, Mo, Nb, Nd, Ni, P, Pb, Pd, Pm, Pr, Pt, Pu, Re, Ru, S, Sb, Sc, Se, Si, Sm, Sn, Sr, Ta, Tb, Te, Ti, Tm, V, W, Y, Yb, Zn, and Zr; and
a thickness variance across the thin film of less than 1.5% of 1-sigma.

37. The thin film of claim 36 wherein the thickness variance across the film is less than or equal to about 1.0% of 1-sigma.

38. The thin film of claim 36 wherein the thin film has a thickness of less than about 100 nm, wherein the film has an absence of detectable pinholes and an absence of detectable particle defects.

39. The thin film of claim 36 wherein the thin film is formed utilizing an ECAE target and wherein the film comprises at least 50% fewer detectible particles relative to a film produced using a non-ECAE target.

40. The thin film of claim 38 wherein the thickness is less than or equal to about 10 nm.

41. The thin film of claim 38 wherein the thickness is less than or equal to about 1.0 nm.

42. The thin film of claim 36 wherein the thin film comprises a metal oxide.

43. The thin film of claim 42 wherein the metal consists essentially of an aluminum alloy.

44. The thin film of claim 43 wherein the alloy comprises at least one of In, Ga and Cu.

45. The thin film of claim 42 wherein the thin film consists essentially of an oxide of an aluminum alloy.

46. The thin film of claim 42 wherein the thin film consists essentially of aluminum, oxygen and at least one of Ga, In and Cu.

47. A physical vapor deposition target comprising an alloy of aluminum and at least one alloying element selected form the group consisting of Ga, Zr and In, a total amount of the at least one alloying element present in the alloy being greater than 1000 ppm, by weight.

48. The physical vapor deposition target of claim 47 wherein the target consists essentially of the alloy.

49. The physical vapor deposition target of claim 47 wherein the target consists essentially of aluminum and Ga.

50. The physical vapor deposition target of claim 49 wherein the alloy contains from greater than 1000 ppm to about 10% of Ga, by weight.

51. The physical vapor deposition target of claim 47 wherein the target consists essentially of aluminum and In.

52. The physical vapor deposition target of claim 51 wherein the alloy contains from greater than 1000 ppm to about 10% of In, by weight.

53. The physical vapor deposition target of claim 47 wherein the alloy consists essentially of aluminum, Ga and In.

54. The physical vapor deposition target of claim 47 wherein the target consists essentially of aluminum and Zr.

55. A thin film stack comprising:
a first layer having a first thickness;
a second layer having a second thickness disposed over the first layer; and
a third layer having a third thickness disposed over the second layer; at least one of the first layer, the second layer and the third layer being a sputtered layer formed by a method comprising ablating material from an equal channel angular extruded target to provide a variance across the sputtered layer of less than or equal to 1% of 1-sigma.

56. The thin film stack of claim 55 wherein the first thickness, the second thickness and the third thickness are each less than 100 nm.

57. The thin film stack of claim 55 wherein the first thickness, the second thickness and the third thickness are each less than 20 nm.

58. The thin film stack of claim 55 wherein the first thickness, the second thickness and the third thickness are each less than 10 nm.

59. The thin film stack of claim 55 wherein the second thickness is less than or equal to 1.0 nm.

60. The thin film stack of claim 55 wherein the at least one layer comprises the second layer and wherein the second layer comprises aluminum.

61. The thin film stack of claim 60 wherein each of the first layer and the second layer are ferromagnetic.

62. The thin film stack of claim 55 wherein the at least one layer comprises the second layer and wherein the second layer comprises copper.

63. The thin film stack of claim 62 wherein each of the first layer and the second layer are ferromagnetic.
